(19) United States
(12) Patent Application Publication
(10) Pub. No.: US 2026/0337448 A1
(43) Pub. Date: Oct. 29, 2026

(54) MULTIPLE-COMPONENT COATING KIT AND METHOD OF USE THEREOF TO IMPART ANTI-ICING CHARACTERISTICS TO ARTICLES

(71) Applicant: Phazebreak Coatings, Inc., Olathe, KS (US)

(72) Inventor: Donald P. Browning, Olathe, KS (US)

(21) Appl. No.: 19/107,294

(22) PCT Filed: Sep. 13, 2023
(86) PCT No.: PCT/US2023/032602

§ 371 Date: Feb. 27, 2025

Related U.S. Application Data
(60) Provisional application No. 63/406,535, filed on Sep. 14, 2022.

(51) Int. Cl. C09D 183/06; C08K 5/5445

(52) U.S. Cl. CPC C09D 183/06; C08K 5/5445

(57) ABSTRACT

A method of imparting anti-icing characteristics to an article includes combining a part A composition with a part B composition and a part C composition to form a ready-to-use composition; applying the ready-to-use composition on at least a portion of a surface of the article; and curing the ready-to-use composition to form a coating on the surface of the article, wherein the part A composition contains an epoxy-silicone; the part B composition contains an aminosilane; and the part C composition contains a silanol-functional silicone, and the part A composition, the part B composition, and the part C composition are packaged separately.

### CROSS REFERENCE TO RELATED APPLICATIONS

This application claims the benefit of U.S. Application No. 63/406,535, filed on Sep. 14, 2022, which is incorporated herein by reference in its entirety.

### BACKGROUND

This disclosure relates to multi-component coating kits and methods of use thereof, in particular to three-component coating kits and methods of using the coating kits to impart anti-icing characteristics to articles. Articles such as aircraft, solar panels, and powerlines are often used under various weather conditions. To protect these articles, a coating is often applied. It would be an advantage if such a coating can have anti-icing characteristics. It would be a further advantage if the coating can have consistent thickness and desired hardness.

### SUMMARY

In an aspect, a method of imparting anti-icing characteristics to an article includes combining a part A composition with a part B composition and a part C composition to form a ready-to-use composition; applying the ready-to-use composition on at least a portion of a surface of the article; and curing the ready-to-use composition to form a coating on the surface of the article, wherein the part A composition contains an epoxy-silicone; the part B composition contains an aminosilane; and the part C composition contains a silanol-functional silicone, and the part A composition, the part B composition, and the part C composition are packaged separately.

In another aspect, a three-component coating kit contains a part A composition including an epoxy-silicone; a part B composition including an aminosilane, a fluorinated silane, and a curing catalyst; and a part C composition including a silanol-functional silicone, wherein the part A composition, the part B composition, the part C composition, or a combination thereof each independently further comprises at least one of a surface-active agent, a heat stabilizer, or an ultraviolet-light absorber; and the part A composition, the part B composition, and the part C composition are packaged separately.

### DETAILED DESCRIPTION

The present disclosure relates to a method of imparting anti-icing characteristics to an article. In particular, the article with imparted anti-icing characteristics may repel water, delay ice formation, hindrance ice adhesion, or facilitate the removal of ice, snow, or frozen contaminants from the coated article.

The method comprises combining separately packaged part A, par B, and part C compositions to form a ready-to-use composition; applying the ready-to-use composition on at least a portion of a surface of the article; and curing the ready-to-use composition to form a coating on the surface of the article. As used herein, the ready-to-use composition is also referred to as a coating composition.

Advantageously, a coating formed from the separately packaged part A, part B, and part C compositions (3K system) can have improved properties as compared to coatings formed from a two-component system (2K system) which includes a first package containing both the same part A composition and the same part C composition, and a second package containing the same part B composition. For example, a coating formed from the 2K system can have an oily residue, especially when the components of the 2K system are stored at room temperature for an extended period of time before use. In addition, the curing time can be longer than desired. Further, under certain circumstances, the coating formed from the 2K system may not be hard enough after cure. In contrast, a coating formed from the separately packaged part A, part B, and part C compositions can have consistent thickness and desired hardness without oily residues, even when the part A, part B, and part C compositions are stored at room temperature for more than 3 months before use. The coating formed from the 3K system can also be cured in a short period of time.

The part A composition comprises an epoxy-silicone. The epoxy-silicone can be a polysiloxane having epoxide functional groups. The epoxy equivalent weight of the epoxy-silicone can be at least about 200 grams, about 200 to about 700 grams, about 300 to about 700 grams, or about 400 to about 600 grams. The epoxide or epoxy equivalent weight (EEW) refers to the mass in grams which one mole of epoxy groups contains. EEW can be determined by ASTM D1652.

The epoxy-silicone can have a polysiloxane framework. Optionally the polysiloxane framework or a side chain of the polysiloxane framework has OH groups and/or alkoxy groups. The epoxy-silicone used is preferably a liquid at 0 to 40 °C. Otherwise the addition of solvents may be needed. It is preferable that the addition of solvents is to be kept as low as possible.

Part B composition comprises an aminosilane. The aminosilane can have a structure represented by Formula I or Formula II

HRN—X—SiR″ₓ(OR′)₃₋ₓ Formula I

HN(X—SiR″ₓ(OR′)₃₋ₓ)ₙ(X′—SiR″_{y}(OR′)_{3-y})ₘ Formula II

wherein in Formula I and Formula II
R is hydrogen, alkyl, cycloalkyl, aryl, or aralkyl;
each occurrence of R′ is independently hydrogen, alkyl, or cycloalkyl;
each occurrence of R″ is independently alkyl, cycloalkyl, aryl, or aralkyl;
each occurrence of X and X′ is independently alkylene, cycloalkylene, or —R₂—NH—R₃—,
   wherein R₂ and R₃ are independently alkylene, or cycloalkylene;
x is 0 to 2, y is 0 to 2, n is 0 to 2, m is 0 to 2, and m+n is 2.

Preferably each of R, R₂, R₃, R′, R″, X, and X′ can each independently have 1 to 20, 1 to 10, or 1 to 6 carbon atoms.

The aminosilane can comprise at least one of a primary aminoalkylalkoxysilane of Formula I when R is H, and R′ is an alkyl group; a secondary aminoalkylalkoxysilane of Formula I when R is an alkyl group, and R′ is an alkyl group; a bisalkoxysilylamine of Formula III; or a diaminosilane of Formula I when X is —R₂—NH—R₃—.

Examples of the primary aminoalkylalkoxysilane include 2-aminoethyltrimethoxysilane, 2-aminoethyltriethoxysilane, 3-aminopropyltrimethoxysilane, 3-aminopropyltriethoxysilane, 4-aminobutyltrimethoxysilane, or 4-aminobutyltriethoxysilane. Preferred primary aminoalkylalkoxysilane is 3-aminopropyltrimethoxysilane or 3-aminopropyltriethoxysilane.

Examples of the secondary aminoalkylalkoxysilane include N-(2-(trimethoxysilyl)ethyl)alkylamines, N-(3-(trimethoxysilyl)propyl)alkylamines, N-(4-(trimethoxysilyl)butyl)alkylamines, N-(2-(triethoxysilyl)ethyl)alkylamines, N-(3-(triethoxysilyl)propyl)alkylamines, or N-(4-(triethoxysilyl)butyl)alkylamines. Preferred secondary aminoalkylalkoxysilane is N-(3-(triethoxysilyl)propyl)butylamine or N-(3-(trimethoxysilyl)propyl)butylamine.

Examples of the bisalkoxysilylamine include bis(2-ethyltrimethoxysilyl)amine, bis(3-propyltrimethoxysil-yl)amine, bis(4-butyltrimethoxysilyl)amine, bis(2-ethyltriethoxysilyl)amine, bis(3-propyltriethoxy-silyDamine, or bis(4-butyltriethoxysilyl)amine.

Examples of the diaminosilane include H₂N—(CH₂)₂NH(CH₂)₂Si(OCH₃)₃, or H₂N(CH₂)₂NH(CH₂); Si(OCH₃)₂CH₃. Diaminosilanes are commercially available, for example, under the trade name SILQUEST A1120, SILQUEST A1120J, or SILQUEST 2120, from Momentive.

The part B composition can also comprise a fluorinated silane. The fluorinated silane can have a structure represented by Formula IV

R₁—Si(OR′)₃ Formula Iv
wherein R₁ is a fluorinated alkyl, and each occurrence of R′ is independently hydrogen, alkyl, or cycloalkyl. Preferably R₁ is a fluorinated C₁₋₂₀ alkyl or a fluorinated C₁₋₁₀ alkyl, and R′ is a C₁₋₁₀ alkyl, C₁₋₅ alkyl, or C₁₋₃ alkyl. A specific example of the fluorinated silane is (tridecafluofo-1,1,2,2-tetrahydrooctyl)trimethoxysilane.

Without wishing to be bound by theory, it is believed that the fluorinated silane can react with the silanol-functional silicone during curing to form a phase change material that imparts anti-icing characteristics to the coating surface. The phase change material may have a structure of the Formula V

R₁Si(OR′)₂—O—(SiR′″₂O)ₙ—SiR′″₂—O—Si(OR′)₂—R₁ Formula V
wherein R₁, R′, and R′″ are the same as described herein in the context of Formula III and Formula IV.

The part C composition comprises a silanol-functional silicone. The silanol-functional silicone can have a structure represented by Formula III

HO—(SiR′″₂O)ₙ—SiR′″₂—OH Formula III

wherein each occurrence of R′″ is independently alkyl, cycloalkyl, aryl, or aralkyl, and n is 2 to 20 or 3 to 10. R′″ can be halogenated. Preferably each R′″ is independently a C₁₋₁₀ or C₁₋₆ alkyl, or phenyl. More preferably each occurrence of R′″ is methyl or phenyl. More preferably each occurrence of R′″ is independently methyl, phenyl, or trifluoropropyl.

The silanol-functional silicone can comprise at least one of a silanol-terminated polydimethylsiloxane, a silanol-terminated polydiphenylsiloxane, a silanol-terminated diphenylsiloxane-dimethylsiloxane copolymer, or a silanol-terminated polytrifluoropropylmethylsiloxane. A silanol-terminated polydimethylsiloxane is preferred. The silanol-terminated polydimethylsiloxane can have a viscosity of about 45 to about 85 centistokes (cSt) measured at room temperature (23°C).

Optionally the part C composition can further comprise an alkyl phosphonate, for example C2-C25 alkyl phosphonate, C5 -C25 alkyl phosphonate, or C8-C20 alkyl phosphonate.

The part A composition, the part B composition, the part C composition or a combination thereof can further comprise at least one of a curing catalyst, a surface-active agent, a heat stabilizer, an ultraviolet-light absorber, or a colorant.

In an aspect, the part A composition further comprises at least one of a surface-active agent, a heat stabilizer, or an ultraviolet-light absorber. The part B composition further comprises a curing catalyst.

The curing catalyst can be present in an amount of about 0.5 to about 5 weight percent, about 1 to about 5 weight percent, or about 0.5 to about 4 weight percent, or about 0.8 to about 3 weight percent, based on a total weight of the part A composition, part B composition, or part C composition, preferably based on a total weight of the part B composition. The curing catalyst can comprise at least one of an organotin compound, an organozinc compound, an organotitanium compound, an organozirconium compound, or an organic acid. Organotin compounds are particularly useful. Examples of the organotin compound include dibutyltin dicarboxylates, such as dibutyltin dilaurate and dibutyltin bis(alkyl maleate); dioctyltin dicarboxylates such as dioctyltin dilaurate, dialkyltin alkoxide derivatives such as dibutyltin dimethoxide and dibutyltin diphenoxide; intramolecular coordination derivatives of dialkyltins, such as dibutyltin diacetylacetonate and dibutyltin acetoacetate; reaction mixtures of dibutyltin oxide with ester compounds; reaction mixtures of dibutyltin oxide with silicate compounds, or tetravalent dialkyltin oxide derivatives such as oxy derivatives of said dialkyltin oxide derivatives as described in U.S. Pat. No. 6,642,309, the content of which is incorporated herein by reference in its entirety. Two or more of the curing catalyst can be used.

As described in U.S. Pat. No. 7,923,513, the content of which is incorporated herein by reference in its entirety, a surface-active agent can modify the interaction of a coating composition with the substrate, in particular, the agent can modify the ability of the composition to wet a substrate. Surface active agents may also include leveling, defoaming, or flow agents, and the like. If used, the surface active agent can be present in an amount of about 0.1 to about 5 weight percent, based on the total weight of the ready-to-use composition, which comprises or consists of the part A composition, the part B composition, and the part C composition.

Surface-active agent is known and can include polysiloxane defoamers such as a methylalkylpolysiloxane commercially available under the trade name BYK-077 or BYK-500 from Byk Chemie, polymeric defoamers such as that commercially available under the trade name BYK 051, or other surface-active agent such as BYK-053, BYK-055, BYK-057, BYK-020, BYK-065, BYK-066N, BYK-067A, BYK-070, BYK-080A, BYK-088, BYK-141, BYK-019, BYK-021, BYK-022, BYK-023, BYK-024, BYK-025, BYK-028, BYK-011, BYK-031, BYK-032, BYK-033, BYK-034, BYK-035, BYK-036, BYK-037, BYK-038, BYK-045, BYK-A530, BYK-A555, BYK-071, BYK-060, BYK-018, BYK-044, BYK-094, BYK 333, BYK A 530, or BYKUMEN, commercially available from Byk Chemie. In an aspect, the coating composition comprises two or more, for example two to six or two to five different surface-active agents.

The light stabilizer can include a hindered amine light stabilizer (HALS). HALS is commercially available, for example, under the trade name BLS 292 from Mayzo, TINUVIN 123 or UVINUL 4092 from BASF Corp., OMNISTAB LS292 from ICG Specialty Chemicals, OMNISTAB LS944 from ICG Specialty Chemicals, SABOSTAB 119 or SABOSTAB 94 from Sabo S.p.A., or LOWILITE from Addivant. If present, the light stabilizer can be used in an amount of 01 to 1 weight percent based on a total weight of the ready-to-use composition, which comprises or consists of the part A composition, the part B composition, and the part C composition. The ready-to-use composition can comprise more than one light stabilizer if needed.

The ultraviolet-light (UV) absorber that can be useful with the coating composition include avobenzone, 2,5-bis(5-tert-butyl-benzoxazol-2-yl)thiophene (Benetex OB+), disodium 4,4′-bis(2-sulfonatostyryl)biphenyl (Benetex OB-M1), benzenepropanoic acid (BLS 99-2), 2,3,6,7-tetrahydro-9-methyl-1H,5H-quinolizino(9,1-gh)coumarin (Coumarin 102), Martius Yellow, morin hydrate, nitrofurazone, 2-nitrophenyl phenyl sulfide (NPS), 5,12-naphthacenequinone (NTAQ), octocrylene, phenazine, 1,4-bis-(2-(5-phenyloxazolyl))-benzene (POPOP), Quinoline Yellow, 3,3′,4′,5,6-pentahydroxyflavone (Quercetin), salicylaldehyde, Sudan I, triamterene, UV386A, or 9,10-diethoxyanthracene (UVS-1101). Other known UV absorbers can also be used. UV absorbers can be used in an amount of 0.05 to 1 weight percent based on a total weight of the ready-to-use composition, which comprise or consists of the part A composition, part B composition, and part C composition. The ready-to-use composition can comprise more than one UV absorber.

The part A composition can comprise about 80 weight percent to about 100 weight percent, about 85 weight percent to about 99 weight percent, or about 88 weight percent to about 98 weight percent of the epoxy-silicone, each based on a total weight of the part A composition. The part B composition can comprise about 75 to about 90 weight percent or about 75 to about 85 weight percent of the aminosilane, about 5 to about 20 weight percent or about 10 to about 20 weight percent of the fluorinated silane, and about 0.5 to about 5 weight percent, or about 1 to about 5 weight percent of the curing catalyst, each based on a total weight of the part B composition. The part C composition can comprise about 90 to about 100 weight percent or about 95 to about 100 weight percent of the silanol-functional silicone, each based on a total weight of the part C composition.

In an aspect, the method further can further comprise providing a coating kit comprising the part A composition, the part B composition, and the part C composition, wherein the part A composition, the part B composition, and the part C composition are packaged separately.

A ready-to-use composition can be made by combining the part A composition with the part B composition and the part C composition. The part A composition, the part B composition, and the part C composition are combined in such a way that the ready-to-use composition comprises about 60 to about 80 weight percent, or about 65 to about 75 weight percent of the epoxy-silicone; about 10 to about 25 weight percent, or about 15 to about 20 weight percent of the aminosilane; about 1 to about 20 weight percent, or about 5 to about 15 weight percent of the silanol-functional silicone; about 0.05 to about 1 weight percent of the curing catalyst, optionally about 0.5 to about 10 weight percent, or about 1 to about 5 weight percent of the fluorinated silane, optionally about 0.1 to about 5 weight percent of the surface active agent, optionally about 0.05 to about 1 weight percent of an UV absorber, and optionally about 0.1 to about 1 weight percent of a light stabilizer, each based on a total weight of the ready-to-use composition. Preferably the solids content of the ready-to-use composition can be greater than 90 vol %, greater than 92 vol %, or greater than 95 vol %. The solids content of the ready-to-use composition can be less than 99.5 vol % or less than 99 vol %.

As used herein, combining includes mixing. The part A, part B, and part C compositions can be mixed shortly before the ready-to-use composition is applied to the substrate. In an aspect, the method comprises mixing the part C composition with the part B composition to form an intermediate composition; and mixing the intermediate composition with the part A composition to form the ready-to-use composition.

The coating composition can be applied by any of the suitable application methods, such as spraying, knife coating, spreading, pouring, dipping, impregnating, trickling or rolling, for example. In the course of such application, the substrate to be coated may itself be at rest, with the application equipment or unit being moved. Alternatively the substrate to be coated may be moved, with the application unit being at rest relative to the substrate or being moved appropriately.

The coating composition can be applied to various substrates such as metallic substrates, polymeric substrates, composite substrates, and the like.

The applied coating composition can be cured after a certain cure time. The cure time may be tuned by adjusting the cure temperature and/or humidity, provided that this does not entail any damage or alteration to the coating, such as premature complete crosslinking, for instance.

A thermal cure can be conducted at a temperature of about 30 to about 200 °C, more preferably about 30 to about 150 °C, and in particular about 30 to about 100°C for a time of about 1 minute (min) up to about 70 hours (h), more preferably about 1 h up to about 60 h, and in particular about 5 h to about 50 h. In a specific embodiment, the ready-to-use composition can achieve 95% hardness in 48 hours when cured at 77°F and 50% relative humidity.

After cure, a coating formed by the separately packaged part A, par B, and part C compositions can consistently have a thickness of about 100 microns to about 500 microns.

Once cured, the coating composition can form a coating that imparts anti-icing characteristics, and the coating can maintain structural integrity with minimized cracking or peeling off with a long service life when used outdoor in low temperature environments.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

Set forth are various aspects of the disclosure.

Aspect 1. A method of imparting anti-icing characteristics to an article, the method comprising: combining a part A composition with a part B composition and a part C composition to form a ready-to-use composition; applying the ready-to-use composition on at least a portion of a surface of the article; and curing the ready-to-use composition to form a coating on the surface of the article; wherein the part A composition comprises an epoxy-silicone; the part B composition comprises an aminosilane; and the part C composition comprises a silanol-functional silicone, and the part A composition, the part B composition, and the part C composition are packaged separately.

Aspect 2. The method as in any prior aspect, further comprising providing a coating kit comprising the part A composition, the part B composition, and the part C composition.

Aspect 3. The method as in any prior aspect, wherein combining the part A composition with the part B composition and the part C composition comprises mixing the part A composition, the part B composition, and the part C composition.

Aspect 4. The method as in any prior aspect, comprising: mixing the part C composition with the part B composition to form an intermediate composition; and mixing the intermediate composition with the part A composition to form the ready-to-use composition.

Aspect 5. The method as in any prior aspect, wherein the part A composition, the part B composition, the part C composition or a combination thereof further comprises at least one of a curing catalyst, a surface-active agent, a heat stabilizer, an ultraviolet-light absorber, or a colorant.

Aspect 6. The method as in any prior aspect, wherein the epoxy-silicone in the part A composition has an epoxy equivalent weight of about 200 to about 700 grams, about 300 to about 700 grams, or about 400 to about 600 grams.

Aspect 7. The method as in any prior aspect, wherein the part A composition further comprises at least one of a surface-active agent, a heat stabilizer, or an ultraviolet-light absorber.

Aspect 8. The method as in any prior aspect, wherein the aminosilane in the part B composition has a structure represented by Formula I or Formula II:

HRN—X—SiR″ₓ(OR′)₃₋ₓ Formula I

HN(X—SiR″ₓ(OR′)₃₋ₓ)ₙ(X′—SiR″_{y}(OR′)_{3-y})ₘ Formula II

wherein in Formula I and Formula II, R is hydrogen, alkyl, cycloalkyl, aryl, or aralkyl; each occurrence of R′ is independently hydrogen, alkyl, or cycloalkyl; each occurrence of R″ is independently alkyl, cycloalkyl, aryl, or aralkyl; each occurrence of X and X′ is independently an alkyl, cycloalkyl, or —R₂—NH—R₃—, wherein R₂ and R₃ are independently alkylene, or cycloalkylene; x is 0 to 2, y is 0 to 2, n is 0 to 2, m is 0 to 2, and m+n is 2.

Aspect 9. The method as in any prior aspect, wherein the part B composition further comprises a fluorinated silane, a curing catalyst, or a combination thereof.

Aspect 10. The method as in any prior aspect, wherein the part B composition further comprises a fluorinated silane having a structure represented by Formula IV

R₁—Si(OR′)₃ Formula IV

wherein R₁ is a fluorinated alkyl, and each occurrence of R′ is independently hydrogen, alkyl, or cycloalkyl.

Aspect 11. The method as in any prior aspect, wherein the silano-functional silicone in the part C composition has a structure represented by Formula III

HO—(SiR′″₂O)—SiR′″₂—OH Formula III

wherein each occurrence of R′″ is independently alkyl, cycloalkyl, aryl or aralkyl, and n is 2 to 20.

Aspect 12. The method as in any prior aspect, wherein the silanol-functional silicone in the part C composition comprises at least one of a silanol-terminated polydimethylsiloxane, a silanol-terminated polydiphenylsiloxane, a silanol-terminated diphenylsiloxane-dimethylsiloxane copolymer, or a silanol-terminated polytrifluoropropylmethylsiloxane.

Aspect 13. The method as in any prior aspect, wherein the part C composition further comprises an alkyl phosphonate.

Aspect 14. The method as in any prior aspect, wherein the part A composition comprises about 80 to about 100 weight percent of the epoxy-silicone; the part B composition comprises about 75 to 90 weight percent of the aminosilane, about 5 to about 20 weight percent of a fluorinated silane, and about 0.5 to about 5 weight percent of a curing catalyst; and the part C composition comprises about 90 to about 100 weight percent of the silanol-functional silicone.

Aspect 15. The method as in any prior aspect, wherein the part A composition, the part B composition, and the part C composition are combined in such a way that the ready-to-use composition comprises about 60 to about 80 weight percent, or about 65 to about 75 weight percent of the epoxy-silicone; about 10 to about 25 weight percent, or about 15 to about 20 weight percent of the aminosilane; about 1 to about 20 weight percent, or about 5 to about 15 weight percent of the silanol-functional silicone, about 0.05 to about 1 weight percent of a curing catalyst; optionally about 0.5 to about 10 weight percent or about 1 to about 5 weight percent of a fluorinated silane; optionally about 0.1 to about 5 weight percent of a surface active agent; optionally about 0.05 to about 1 weight percent of an UV absorber; and optionally about 0.1 to about 1 weight percent of a light stabilizer; each based on a total weight of the ready-to-use composition.

Aspect 16. The method as in any prior aspect, wherein the coating has a thickness of about 100 microns to about 500 microns.

Aspect 17. A three-component coating kit comprising a part A composition comprising an epoxy-silicone; a part B composition comprising an aminosilane, a fluorinated silane, and a curing catalyst; and a part C composition comprising a silanol-functional silicone, wherein the part A composition, the part B composition, the part C composition, or a combination thereof each independently further comprises at least one of a surface-active agent, a heat stabilizer, or an ultraviolet-light absorber; and the part A composition, the part B composition, and the part C composition are packaged separately.

Aspect 18. The three-component coating kit as in any prior aspect, wherein the part A composition comprises about 90 to about 100 weight percent of the epoxy-silicone, based on a total weight of the part A composition; the part B composition comprises about 75 to 90 weight percent of the aminosilane, about 5 to about 20 weight percent of a fluorinated silane, and about 0.5 to about 5 weight percent of the curing catalyst, based on a total weight of the part B composition; and the part C composition comprises about 90 to about 100 weight percent of the silanol-functional silicone,, based on a total weight of the part C composition.

The singular forms “a,” “an,” and “the” include plural referents unless the context clearly dictates otherwise. “Or” means “and/or” unless clearly indicated otherwise by context. The modifier “about” used in connection with a quantity is inclusive of the stated value (e.g., “about 25-50 wt %” is a disclosure of “25-50 wt. %”) and has the meaning dictated by the context (e.g., includes the degree of error associated with measurement of the particular quantity). The terms “about”, “substantially” and “generally” are intended to include the degree of error associated with measurement of the particular quantity based upon the equipment available at the time of filing the application. For example, “about” and/or “substantially” and/or “generally” can include a range of ±8% or 5%, or 2% of a given value.

“Optional” or “optionally” means that the subsequently described event or circumstance can or cannot occur, and that the description includes instances where the event occurs and instances where it does not. A “combination” is inclusive of blends, mixtures, alloys, reaction products, and the like.

As used herein, the term “hydrocarbyl” and “hydrocarbon” refers broadly to a substituent comprising carbon and hydrogen, optionally with 1 to 3 heteroatoms, for example, oxygen, nitrogen, halogen, silicon, sulfur, or a combination thereof; “alkyl” refers to a straight or branched chain, saturated monovalent hydrocarbon group; “alkylene” refers to a straight or branched chain, saturated, divalent hydrocarbon group; “cycloalkyl” refers to a non-aromatic monovalent monocyclic or multicylic hydrocarbon group having at least three carbon atoms; “aryl” refers to an aromatic monovalent group containing only carbon in the aromatic ring or rings; “arylene” refers to an aromatic divalent group containing only carbon in the aromatic ring or rings; and “arylalkyl” refers to an alkyl group that has been substituted with an aryl group as defined above, with benzyl being an exemplary arylalkyl group.

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded.

All cited patents, patent applications, and other references are incorporated herein by reference in their entirety. If a term in the present application contradicts or conflicts with a term in an incorporated reference, the term from the present application takes precedence over the conflicting term from the incorporated reference.

While embodiments have been set forth for the purpose of illustration, the foregoing descriptions should not be deemed a limitation on the scope herein. Accordingly, various modifications, adaptations, and alternatives can occur to one skilled in the art without departing from the spirit and scope herein.

What is claimed is:

1. A method of imparting anti-icing characteristics to an article, the method comprising:
combining a part A composition with a part B composition and a part C composition to form a ready-to-use composition;
applying the ready-to-use composition on at least a portion of a surface of the article; and
curing the ready-to-use composition to form a coating on the surface of the article;
wherein the part A composition comprises an epoxy-silicone;
the part B composition comprises an aminosilane; and
the part C composition comprises a silanol-functional silicone, and
the part A composition, the part B composition, and the part C composition are packaged separately.

2. The method of claim 1, further comprising providing a coating kit comprising the part A composition, the part B composition, and the part C composition.

3. The method of claim 1, wherein combining the part A composition with the part B composition and the part C composition comprises mixing the part A composition, the part B composition, and the part C composition.

4. The method of claim 1, comprising:
mixing the part C composition with the part B composition to form an intermediate composition; and
mixing the intermediate composition with the part A composition to form the ready-to-use composition.

5. The method of claim 1, wherein the part A composition, the part B composition, the part C composition or a combination thereof further comprises at least one of a curing catalyst, a surface-active agent, a heat stabilizer, an ultraviolet-light absorber, or a colorant.

6. The method of claim 1, wherein the epoxy-silicone in the part A composition has an epoxy equivalent weight of about 200 to about 700 grams, about 300 to about 700 grams, or about 400 to about 600 grams.

7. The method of claim 1, wherein the part A composition further comprises at least one of a surface-active agent, a heat stabilizer, or an ultraviolet-light absorber.

8. The method of claim 1, wherein the aminosilane in the part B composition has a structure represented by Formula I or Formula II:
HRN—X—SiR″ₓ(OR′)₃₋ₓ Formula I
HN(X—SiR″ₓ(OR′)₃₋ₓ)ₙ(X′—SiR″_{y}(OR′)_{3-y})ₘ Formula II
wherein in Formula I and Formula II
R is hydrogen, alkyl, cycloalkyl, aryl, or aralkyl;
each occurrence of R′ is independently hydrogen, alkyl, or cycloalkyl;
each occurrence of R″ is independently alkyl, cycloalkyl, aryl, or aralkyl;
each occurrence of X and X′ is independently an alkyl, cycloalkyl, or —R₂—NH—R₃—,
wherein R₂ and R₃ are independently alkylene, or cycloalkylene;
x is 0 to 2, y is 0 to 2, n is 0 to 2, m is 0 to 2, and m+n is 2.

9. The method of claim 1, wherein the part B composition further comprises a fluorinated silane, a curing catalyst, or a combination thereof.

10. The method of claim 1, wherein the part B composition further comprises a fluorinated silane having a structure represented by Formula IV
R₁—Si(OR′)₃ Formula IV
wherein
R₁ is a fluorinated alkyl, and
each occurrence of R′ is independently hydrogen, alkyl, or cycloalkyl.

11. The method of claim 1, wherein the silano-functional silicone in the part C composition has a structure represented by Formula III
HO—(SiR′″₂O)ₙ—SiR′″₂—OH Formula III
wherein each occurrence of R′″ is independently alkyl, cycloalkyl, aryl or aralkyl, and n is 2 to 20.

12. The method of claim 1, wherein the silanol-functional silicone in the part C composition comprises at least one of a silanol-terminated polydimethylsiloxane, a silanol-terminated polydiphenylsiloxane, a silanol-terminated diphenylsiloxane-dimethylsiloxane copolymer, or a silanol-terminated polytrifluoropropylmethylsiloxane.

13. The method of claim 1, wherein the part C composition further comprises an alkyl phosphonate.

14. The method of claim 1, wherein
the part A composition comprises about 80 to about 100 weight percent of the epoxy-silicone;
the part B composition comprises about 75 to 90 weight percent of the aminosilane, about 5 to about 20 weight percent of a fluorinated silane, and about 0.5 to about 5 weight percent of a curing catalyst; and
the part C composition comprises about 90 to about 100 weight percent of the silanol-functional silicone.

15. The method of claim 1, wherein the part A composition, the part B composition, and the part C composition are combined in such a way that the ready-to-use composition comprises
about 60 to about 80 weight percent, or about 65 to about 75 weight percent of the epoxy-silicone;
about 10 to about 25 weight percent, or about 15 to about 20 weight percent of the aminosilane;
about 1 to about 20 weight percent, or about 5 to about 15 weight percent of the silanol-functional silicone;
about 0.05 to about 1 weight percent of a curing catalyst;
optionally about 0.5 to about 10 weight percent or about 1 to about 5 weight percent of a fluorinated silane;
optionally about 0.1 to about 5 weight percent of a surface active agent;
optionally about 0.05 to about 1 weight percent of an UV absorber; and
optionally about 0.1 to about 1 weight percent of a light stabilizer;
cach based on a total weight of the ready-to-use composition.

16. The method of claim 1, wherein the coating has a thickness of about 100 microns to about 500 microns.

17. A three-component coating kit comprising
a part A composition comprising an epoxy-silicone;
a part B composition comprising an aminosilane, a fluorinated silane, and a curing catalyst; and
a part C composition comprising a silanol-functional silicone,
wherein the part A composition, the part B composition, the part C composition, or a combination thereof each independently further comprises at least one of a surface-active agent, a heat stabilizer, or an ultraviolet-light absorber; and
the part A composition, the part B composition, and the part C composition are packaged separately.

18. The three-component coating kit of claim 17, wherein
the part A composition comprises about 90 to about 100 weight percent of the epoxy-silicone, based on a total weight of the part A composition;
the part B composition comprises about 75 to 90 weight percent of the aminosilane, about 5 to about 20 weight percent of a fluorinated silane, and about 0.5 to about 5 weight percent of the curing catalyst, based on a total weight of the part B composition; and
the part C composition comprises about 90 to about 100 weight percent of the silanol-functional silicone,, based on a total weight of the part C composition.
